(19) United States
(12) Patent Application Publication
(10) Pub. No.: US 2025/0343863 A1
(43) Pub. Date: Nov. 6, 2025

(54) INSPECTION APPARATUS, IMAGE FORMING SYSTEM, ABNORMALITY DETECTION METHOD, AND RECORDING MEDIUM

(71) Applicant: Konica Minolta, Inc., Tokyo (JP)

(72) Inventor: Hiroaki Yago, Tokyo (JP)

(73) Assignee: Konica Minolta, Inc., Tokyo (JP)

(21) Appl. No.: 19/194,818

(22) Filed: Apr. 30, 2025

(30) Foreign Application Priority Data
May 1, 2024 (JP) 2024-074393

(51) Int. Cl. H04N 1/00

(52) U.S. Cl. CPC H04N 1/00005; H04N 1/00015; H04N 1/00023; H04N 1/00029; H04N 1/0009; H04N 1/00092

(57) ABSTRACT

Provided is an inspection apparatus that includes a hardware processor. The hardware processor acquires pre-printing base information of a recording medium before printing and post-printing base information of the recording medium after the printing, and determines based on the pre-printing base information and the post-printing base information whether there is an abnormality in the recording media after the printing.

### CROSS REFERENCE TO RELATED APPLICATIONS

The entire disclosure of Japanese Patent Application No. 2024-074393, filed on May 1, 2024, is incorporated herein by reference in its entirety.

### BACKGROUND

### Technological Field

The present invention relates to an inspection apparatus, an image forming system, an abnormality detection method, and a recording medium.

### Description of Related Art

In the related art, there is known an image forming system in which an inspector is disposed at a subsequent stage of an image forming apparatus that forms an image on a recording medium (see, for example. Japanese Patent Publication Laid-Open No. 2019-194598). The inspection apparatus inspects whether there is an abnormality in a recording medium on which an image has been formed.

In such an image forming system, a sheet having unevenness, such as embossed paper, may be used as a recording medium. In a case where embossed paper is used as a recording medium, unevenness of the sheet is read as a base pattern.

Meanwhile, in a case where embossed paper having unevenness is used as a recording medium, toner may not be appropriately put on the sheet when an image is formed on the sheet and the toner may be scattered in a base region other than a print region in which the image is formed. In this case, it is difficult to determine whether the base pattern is due to the unevenness of the sheet or due to the scattered toner.

For this reason, the image forming system in the related art has a problem in which, even when an abnormality occurs due to toner scattering or the like, the image forming system cannot appropriately detect the abnormality.

### SUMMARY

An object of the present invention is to provide an inspection apparatus, an image forming system, an abnormality detection method, and a recording medium each capable of accurately detecting an abnormality in a recording medium on which an image has been formed.

In order to achieve at least one of the above-described objects, an inspection apparatus reflecting one aspect of the present invention includes a hardware processor.

The hardware processor acquires pre-printing base information of a recording medium before printing and post-printing base information of the recording medium after the printing, and determines based on the pre-printing base information and the post-printing base information whether there is an abnormality in the recording medium after the printing.

An image forming system reflecting another aspect of the present invention includes:
a reading apparatus that reads pre-printing base information of a recording medium before printing to be conveyed:
an image forming apparatus that forms an image on the recording medium conveyed from the reading apparatus; and
the inspection apparatus described above.

An abnormality detection method reflecting yet another aspect of the present invention includes: acquiring pre-printing base information of a recording medium before printing and post-printing base information of the recording medium after the printing; and
determining based on the pre-printing base information and the after-printing base information whether there is an abnormality in the recording medium after the printing.

A non-transitory computer-readable recording medium reflecting still another aspect of the present invention stores a program that causes a computer to execute the abnormality detection method described above.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a schematic diagram illustrating an exemplary configuration of an image forming system according to the present embodiment;

FIG. 2 is a block diagram illustrating a main portion of a control system of the image forming system according to the present embodiment:

FIG. 3 is a functional block diagram illustrating an exemplary configuration of the controller in FIG. 2;

FIG. 4 is a schematic diagram for describing sheet reading:

FIG. 5 is a schematic diagram for describing a state in which toner is scattered on a sheet:

FIG. 6 is a schematic diagram for describing a first exemplary color distribution range in the base region of a sheet:

FIG. 7 is a schematic diagram for describing a second exemplary color distribution range in the base region of a sheet:

FIG. 8 is a schematic diagram for describing a third exemplary color distribution range in the base region of a sheet:

FIG. 9 is a schematic diagram for describing a fourth exemplary color distribution range in the base region of a sheet; and

FIG. 10 is a flowchart illustrating an exemplary flow of abnormality detection processing according to the present embodiment.

### DETAILED DESCRIPTION OF EMBODIMENTS

Hereinafter, one or more embodiments of the present invention will be described with reference to the drawings. However, the scope of the invention is not limited to the disclosed embodiments.

In the drawings, components denoted by identical reference signs are identical or equivalent components, which is commonly applied throughout the specification in its entirety.

Hereinafter, an embodiment of the present disclosure will be described with reference to the accompanying drawings. An image forming system according to the present embodiment is capable of forming an image on a sheet (recording medium) such as a flat sheet. Note that, hereinafter, a case where a sheet is used as a recording medium will be described as an example, but the recording medium is not limited to a sheet, and any other medium such as cloth may be used, for example.

### [Configuration of Image Forming System 1]

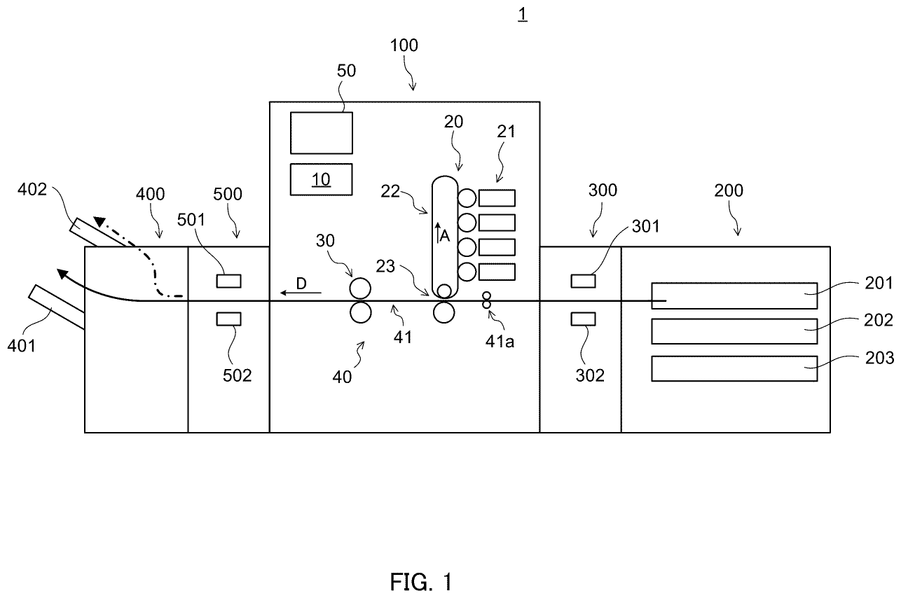

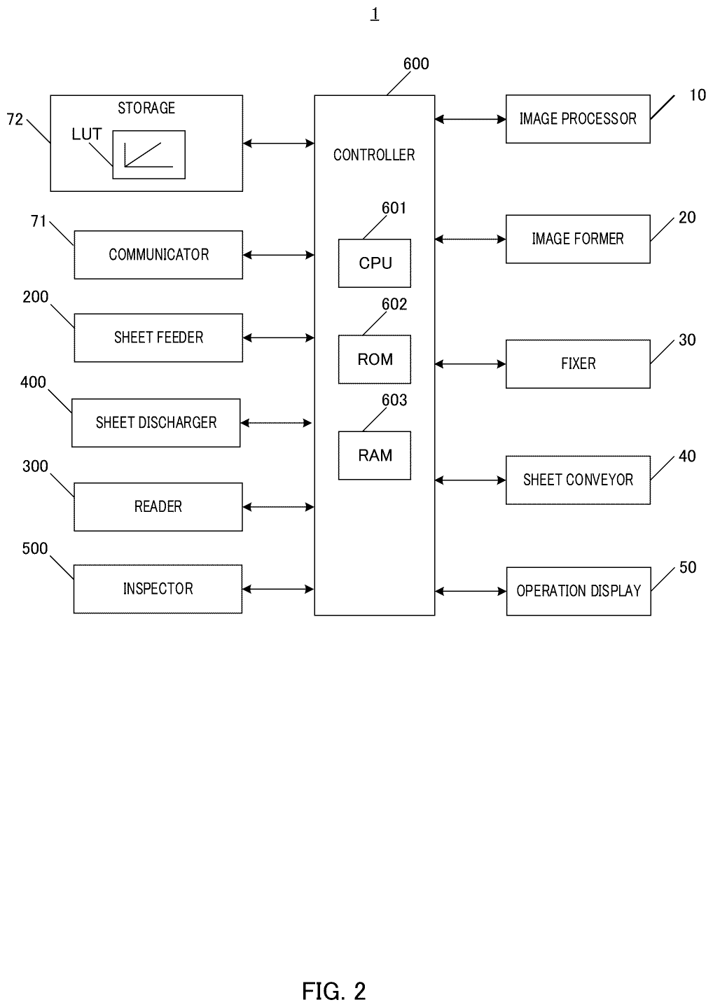

FIG. 1 is a schematic diagram illustrating an exemplary configuration of an image forming system 1 according to the present embodiment. FIG. 2 is a block diagram illustrating a main portion of a control system of the image forming system 1 according to the present embodiment. As illustrated in FIG. 1, the image forming system 1 is configured to include an image forming apparatus 100, a sheet feeder 200, a reader 300, an inspector 500, a sheet discharger 400, and the like.

The image forming apparatus 100 is a color image forming apparatus of an intermediate transfer system utilizing an electrophotographic process technology. That is, the image forming apparatus 100 performs primary transfer of toner images of the respective colors of CMYK formed onto a photoreceptor to an intermediate transfer member, and performs secondary transfer of the toner images of the four colors onto a sheet after the toner images of the four colors are superposed on the intermediate transfer member to form an image. Note that. CMYK stands for cyan (C), magenta (M), yellow (Y), and black (K).

The image forming apparatus 100 adopts a tandem system in which photoreceptors corresponding to the four colors of CMYK are arranged in series in a travel direction of an intermediate transfer member, and the toner images of the respective colors are sequentially transferred onto the intermediate transfer member by a single procedure.

As illustrated in FIG. 2, the image forming system 1 includes an image processor 10, an image former 20, a fixer 30, a sheet conveyor 40, an operation display 50, a communicator 71, a storage 72, a controller 600, the sheet feeder 200, the reader 300, the inspector 500, the sheet discharger 400, and the like.

The image processor 10 includes a circuit or the like that performs image processing on input image data according to initial settings or user settings. The image former 20 is controlled based on image data subjected to the image processing.

The image former 20 includes image forming units 21, an intermediate transfer unit 22, and a secondary transfer unit 23. The image forming units 21 form an image with the color toners of the respective color components based on image data from the image processor 10. For example, the image forming units 21 form an image with the color toners of the respective color components of yellow (Y), magenta (M), cyan (C), and black (K).

The image forming units 21 include, for each color, an exposure apparatus, a developing apparatus, a photosensitive drum, a charging apparatus, a drum cleaning apparatus, and the like. Since techniques known in the art can be adopted as the exposure apparatus, the developing apparatus, the photosensitive drum, the charging apparatus, and the drum cleaning apparatus, detailed descriptions thereof are omitted here.

The intermediate transfer unit 22 includes an intermediate transfer belt and the like. The intermediate transfer belt is stretched around a plurality of support rollers in a loop shape, and travels in a direction of an arrow A. The support rollers include rollers such as a backup roller, a primary transfer roller, and a drive roller, but illustration thereof is omitted here. The intermediate transfer belt is pressed against the photosensitive drums, and thus, the toner images are transferred from the photosensitive drums to the intermediate transfer belt.

Note that the intermediate transfer unit 22 may be configured to include a belt cleaning apparatus including a plate-like belt cleaning blade or the like that comes into sliding contact with the surface of the intermediate transfer belt. The belt cleaning apparatus removes transfer residual toner and the like remaining on the surface of the intermediate transfer belt after the secondary transfer.

The secondary transfer unit 23 includes a secondary transfer roller and the like. The secondary transfer roller is pressed against the intermediate transfer belt. Thus, a secondary transfer nip is formed between the intermediate transfer belt and the secondary transfer roller.

In the secondary transfer unit 23, when a sheet is conveyed to the secondary transfer nip, the toner images of the respective colors carried on the intermediate transfer belt are collectively transferred onto the sheet. The sheet onto which the toner images have been transferred is conveyed toward the fixer 30 by the secondary transfer roller.

Note that the secondary transfer unit 23 may also be a belt-type secondary transfer unit including a secondary transfer belt stretched around a plurality of support rollers, or the like, instead of a roller-type secondary transfer unit including a secondary transfer roller or the like.

The fixer 30 includes a fixing roller, a pressure roller, and the like. The fixing roller is heated to a predetermined fixing temperature, and the pressure roller forms a fixing nip for holding and conveying a sheet between the pressure roller and the fixing roller. The fixer 30 heats and pressurizes a conveyed sheet onto which the toner images have been secondarily transferred, thereby fixing the toner images on the sheet.

The sheet conveyor 40 includes a conveyance path 41 and the like. The conveyance path 41 is constituted by, for example, a path for conveying a sheet, a plurality of conveyance rollers, and a drive motor for rotation-driving these conveyance rollers. The conveyance path 41 conveys a sheet supplied from the sheet feeder 200 to the secondary transfer unit 23 and the fixer 30, and then to the sheet discharger 400.

In the conveyance path 41, a registration roller pair 41a is provided on the upstream side of the second transfer unit 23 in a sheet conveyance direction D. The registration roller pair 41a adjusts conveyance timing and a direction (angle) of a sheet to be conveyed to the secondary transfer unit 23.

The operation display 50 is constituted by, for example, a liquid crystal display (LCD) with a touch screen or the like, and functions as a display and an operator. The display displays various operation screens, the state of an image, operating situations of the respective functions, and the like according to display control signals received from the controller 600. The operator includes various operation keys such as a numeric keypad and a start key, accepts various input operations by a user, and outputs an operation signal to the controller 600.

The sheet feeder 200 is disposed on the upstream side of the image forming apparatus 100 in the sheet conveyance direction D and is connected to the image forming apparatus 100. The sheet feeder 200 corresponds to the “supply apparatus” of the present disclosure.

The sheet feeder 200 includes a plurality of sheet feeding trays 201, 202, and 203. In each of the sheet feeding trays 201, 202, and 203, flat sheets (standard sheets or special sheets) identified based on the basis weight, the size, or the like are accommodated for each type set in advance. The sheet feeder 200 supplies an instructed sheet to the side of the image forming apparatus 100 based on an instruction from the image forming apparatus 100.

The reader 300 is disposed between the sheet feeder 200 and the image forming apparatus 100, is connected to the sheet feeder 200 on the upstream side in the sheet conveyance direction D. and is connected to the image forming apparatus 100 on the downstream side in the sheet conveyance direction D. The reader 300 corresponds to the “reading apparatus” of the present disclosure.

The reader 300 includes sensors 301 and 302 that read the sheet conveyed from the sheet feeder 200. The sensor 301 is disposed on the upper side of a path along which a sheet is conveyed, is disposed facing the side of the sheet to be conveyed, and is configured to read the side of the front surface (upper surface) of the sheet to be conveyed. The sensor 302 is disposed on the lower side of the path along which a sheet is conveyed, is disposed facing the side of the sheet to be conveyed, and is configured to read the side of the back surface (lower surface) of the sheet to be conveyed.

As the sensors 301 and 302, for example, a charge coupled device (CCD), a contact image sensor (CIS), or the like is used. In addition, as the sensors 301 and 302, a line sensor which extends over a width equal to or more than the width of the sheet (the width in the direction orthogonal to the sheet conveyance direction D), for example, a line scanner, a line sensor camera, or the like is used.

The sensors 301 and 302 acquire sheet information that is information on a sheet. The sensors 301 and 302 acquire, for example, the size (the sheet width, the sheet length, and the like) of the sheet, the sheet position, and the like as the sheet information. Further, in the present embodiment, the sensors 301 and 302 acquire, as one type of sheet information, base information including color information such as the color and brightness of the sheet on which an image has not been yet formed.

Note that, here, as an example, the reader 300 is configured to include the sensors 301 and 302 that read both surfaces (front and rear surfaces) of the sheet, but is not limited thereto, and may be configured to include only the sensor 301 that reads one surface (front surface) of the sheet, for example.

The sheet discharger 400 is disposed on the downstream side of the inspector 500 in the sheet conveyance direction D. and is connected to the image forming apparatus 100 via the inspector 500. The sheet discharger 400 includes a sheet discharging tray 401 and a purge tray 402, and discharges the conveyed sheet to the sheet discharging tray 401 or the purge tray 402.

The sheet discharging tray 401 discharges a sheet on which an image has been formed by the image forming apparatus 100. The purge tray 402 discharges a sheet whose sheet size does not satisfy a predetermined condition as a result of the sheet size being read by the reader 300. For example, in a case where a sheet size read by the reader 300 does not satisfy the predetermined condition, the sheet discharger 400 may discharge, from the purge tray 402, a sheet on which no image has been formed by the image forming apparatus 100, as indicated by a one dot chain arrow in FIG. 1.

The inspector 500 is disposed between the image forming apparatus 100 and the sheet discharger 400 in the sheet conveyance direction D. The inspector 500 is connected to the image forming apparatus 100 on the upstream side and is connected to the sheet discharger 400 on the downstream side. The inspector 500 corresponds to the “inspection apparatus” of the present disclosure.

The inspector 500 inspects whether there is an abnormality in a sheet on which an image has been formed by the image forming apparatus 100. The inspector 500 includes sensors 501 and 502 that read a sheet conveyed from the image forming apparatus 100.

The sensor 501 is disposed on the upper side of a path along which a sheet is conveyed, is disposed facing the side of the sheet to be conveyed, and is configured to read the side of the front surface (upper surface) of the sheet to be conveyed. The sensor 502 is disposed on the lower side of the path along which a sheet is conveyed, is disposed facing the side of the sheet to be conveyed, and is configured to read the side of the back surface (lower surface) of the sheet to be conveyed.

As the sensors 501 and 502, for example, in the same manner as the sensors 301 and 302 of the reader 300, a CCD, a CIS, or the like is used. In addition, as the sensors 501 and 502, a line sensor which extends over a width equal to or more than the width of the sheet (the width in the direction orthogonal to the sheet conveyance direction D), for example, a line scanner, a line sensor camera, or the like is used. The sensors 501 and 502 acquire base information of a sheet on which an image has been formed.

The sensors 501 and 502 acquire, as one type of sheet information, base information including color information such as the color and brightness of a sheet on which an image has been formed. Note that, here, as an example, the inspector 500 is configured to include the sensors 501 and 502 which read both surfaces (front and rear surfaces) of the sheet, but is not limited thereto, and may be configured to include only the sensor 501 which reads one surface (front surface) of the sheet, for example.

The image processor 10, the image former 20, the fixer 30, the sheet conveyor 40, the operation display part 50, the communicator 71, the storage 72, the sheet feeder 200, the reader 300, the inspector 500, and the sheet discharger 400, which have been described above, are connected to the controller 600. The controller 600 gives various instructions to these units and executes predetermined processing.

The controller 600 includes a central processing unit (CPU) 601, a read only memory (ROM) 602, a random access memory (RAM) 603, and the like. The CPU 601 reads a program corresponding to the processing content from the ROM 602, develops the program in the RAM 603, and centrally controls the operation of each block of the image forming system 1 in cooperation with the developed program. At this time, various data such as a look up table (LUT) stored in the storage 72 are referred to. The storage 72 is constituted by, for example, a non-volatile semiconductor memory (so-called flash memory) or a hard disk drive. The CPU 601 is an example of a hardware processor that functions as the controller 600.

The controller 600 transmits/receives various data to/from an external apparatus (for example, a personal computer) connected to a communication network such as a local area network (LAN), a wide area network (WAN) via the communicator 71. The controller 600 receives, for example, image data transmitted from the external apparatus, and causes an image to be formed on a sheet based on the image data (input image data). The communicator 71 is constituted by a communication control card such as a LAN card.

In the present Embodiment 1, the controller 600 performs, based on base information of a sheet before and after printing, abnormality detection processing of detecting an abnormality in a recording medium on which an image has been formed. Details of the abnormality detection processing will be described later.

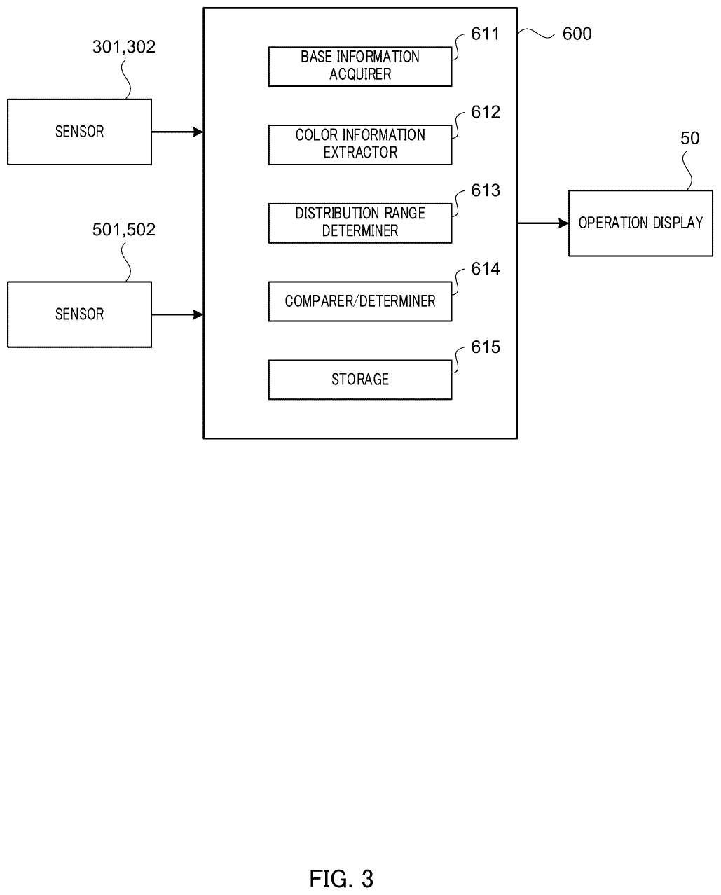

FIG. 3 is a functional block diagram illustrating an exemplary configuration of the controller 600 in FIG. 2. As illustrated in FIG. 3, the controller 600 includes a base information acquirer 611, a color information extractor 612, a distribution range determiner 613, a comparer/determiner 614, and a storage 615.

The base information acquirer 611 acquires pre-printing base information from the sensors 301 and 302 of the reader 300. Further, the base information acquirer 611 acquires post-printing base information from the sensors 501 and 502 of the inspector 500.

The pre-printing base information is base information of a sheet before printing, which has been read by the sensors 301 and 302 of the reader 300. The post-print base information is base information of a sheet after printing, which has been read by the sensors 501 and 502 of the inspector 500.

The color information extractor 612 extracts pre-printing color information from the pre-printing base information. Further, the color information extractor 612 extracts post-printing color information from the post-printing base information. The pre-printing color information is information on a color(s) in the base region of a sheet before printing, and is included in the pre-printing base information. The pre-printing color information includes, for example, information on the color and brightness of a sheet. The post-printing color information is information on a color(s) in the base region of a sheet after printing, and is included in the post-printing base information. The post-printing color information includes, for example, information on the color and brightness of a sheet.

The distribution range determiner 613 determines a pre-printing color distribution range based on the pre-printing color information. Further, the distribution range determiner 613 determines a post-printing color distribution range based on the post-printing color information. The pre-printing color distribution range is a color distribution range in the base region of a sheet before printing. The post-printing color distribution range is a color distribution range in the base region of a sheet after printing.

The comparer/determiner 614 determines based on the pre-printing color distribution range and the post-printing color distribution range whether there is an abnormality in a sheet on which an image has been formed. For example, the comparer/determiner 614 compares the pre-printing color distribution range with the post-printing color distribution range. Then, the comparer/determiner 614 determines whether the respective color distribution ranges coincide with each other. The comparer/determiner 614 corresponds to the “abnormality determiner” of the present disclosure.

The storage 615 stores various data to be used in each unit of the controller 600. For example, the storage 615 stores pre-printing base information read by the reader 300.

### [Operations of Image Forming System 1]

Operations of the image forming system 1 according to the present Embodiment 1 having the above-described configuration will be described. In a case where an image is formed on a sheet, which is a recording medium, in the image forming system 1, sheets are accommodated in the sheet feeding trays 201, 202, and 203 of the sheet feeder 200. Then, a sheet supplied from the sheet feeder 200 is conveyed to the reader 300, the pre-printing base information including the pre-printing color information of the sheet is read, and then the sheet is conveyed to the image forming apparatus 100.

Here, when the reader 300 reads the base information from the sheet, the reader 300 extracts a region-outside-print-region, which is a region other than a print region in which an image is formed, as a base region, and reads the base information from the base region. The print region and the base region can be extracted using, for example, a method known in the art.

Note that, in a case where the print region is set in advance, the reader 300 may extract the base region based on the setting of the print region. Further, in a case where the print region is not set in advance, the reader 300 may read the base information from the entire region of the sheet, for example.

The sheet conveyed to the image forming apparatus 100 is subjected to image formation (hereinafter, referred to as “printing” as appropriate) at the image forming apparatus 100, and is conveyed to the inspector 500. The sheet conveyed to the inspector 500 is subjected to the abnormality detection processing, and it is inspected whether there is an abnormality in the sheet after the printing. Then, the sheet whose inspection has been completed is conveyed to the sheet discharger 400.

### [Abnormality Detection Processing]

Next, the abnormality detection processing according to the present embodiment will be described.

As described in the Background section, in a case where printing is performed using a sheet having unevenness, such as embossed paper, as a recording medium, the unevenness of the sheet is read as a base (pattern). FIG. 4 is a schematic diagram for describing sheet reading. As illustrated in FIG. 4, in a case where the surface of embossed paper having unevenness is read before printing, the unevenness is read as a base pattern.

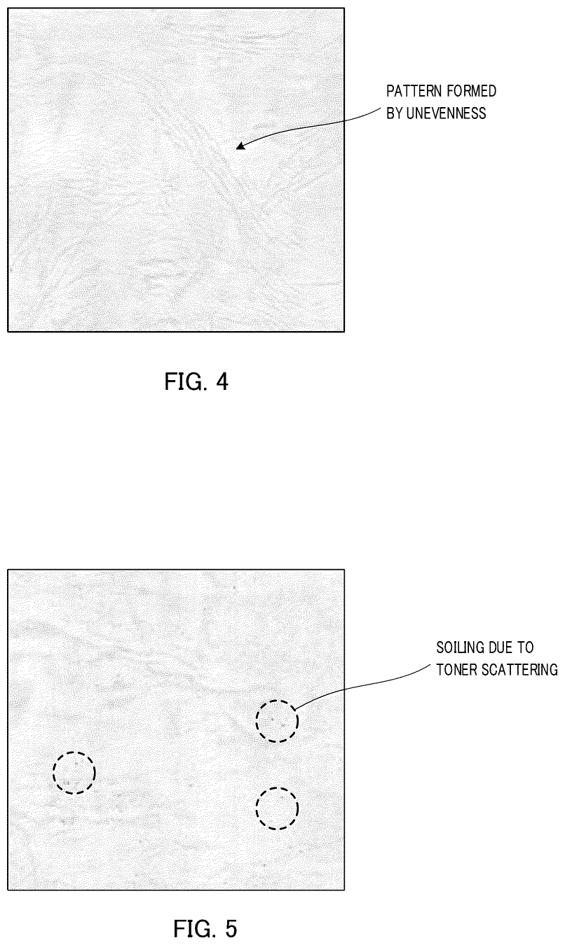

On the other hand, in a case where embossed paper is used, toner may be scattered in a base region without landing on the sheet when an image is formed on the sheet due to the shape of a photosensitive drum or the distribution state of charges in the image forming apparatus 100. FIG. 5 is a schematic diagram for describing a state in which toner is scattered on a sheet. As illustrated in FIG. 5, in a case where the surface of embossed paper is read after printing, soiling may occur due to toner scattering in the base region as illustrated by the broken-line circles.

In a case where toner is scattered in the base region as described above, it is difficult to determine whether the pattern of the base region is due to irregularities of the sheet or due to the scattered toner. Accordingly, in the present embodiment, the base information of a sheet before printing is read in advance, and the abnormality detection processing of accurately detecting an abnormality in the sheet, on which an image has been formed, is performed based on the base information before the printing read in advance and the base information read after the printing.

### (Color Distribution Range in Base Region)

In the abnormality detection processing, attention is paid to color distribution ranges of a sheet before and after printing. Here, consideration is given to color distribution ranges in a Lab color space in the base region of a sheet before and after printing. A Lab color space is a color system having a dimension “L” indicating lightness and dimensions “a” and “b” indicating hue and saturation.

For example, consideration is given to a case where white embossed paper before printing is read. In this case, the base pattern in the base region due to unevenness of the embossed paper is represented by gradations of white and black. Accordingly, a pre-printing color distribution range, which is a color distribution range in the base before printing, is based on color information represented by gradations of white and black.

In contrast, in a case where toner is scattered in the base region during printing, a post-printing color distribution range, which is a color distribution range in the base region, is different from a pre-printing color distribution range. Specifically, a post-printing color distribution range is based on color information corresponding to the color of scattered toner in addition to color information indicating a pre-printing color distribution range. That is, a post-printing color distribution range in a case where toner is scattered in the base region has a distribution which deviates from a pre-printing color distribution range.

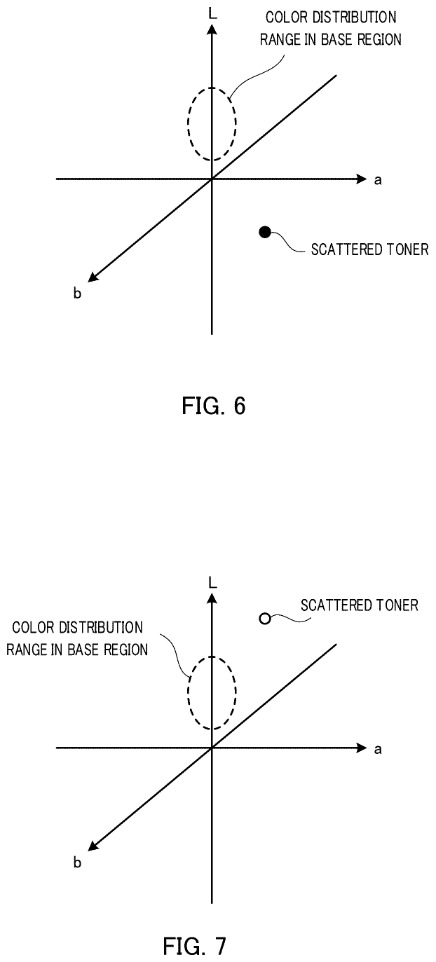

FIG. 6 is a schematic diagram for describing a first exemplary color distribution range in the base region of a sheet. FIG. 6 illustrates a Lab color space. As illustrated in FIG. 6, a pre-printing color distribution range, which is a color distribution range in the base region of white embossed paper before printing, is formed on the L axis in the Lab color space.

FIG. 6 illustrates a pre-printing color distribution range in the base region of the sheet before printing and the position of toner scattered during printing in a Lab color space, in the case of printing on white embossed paper. In addition, the toner scattered in the base region is located at coordinates different from those of the pre-printing color distribution range.

As described above, the color distribution ranges in the base region are different in a case where an abnormality such as toner scattering occurs. Accordingly, by comparing color distribution ranges in the base region before and after printing, it is possible to detect whether there is an abnormality in a sheet on which an image has been formed.

(Case where Lightness L of Toner is Large)

Incidentally, in a case where the brightness L of scattered toner is large, the tint becomes close to white. For this reason, in a case where a white sheet is used as a recording medium, scattered toner is less likely to be visually distinguished from the base pattern. Accordingly, in a case where the lightness L of toner is large, it may also be configured such that even deviation of a distribution based on color information of toner from a pre-printing color distribution range is not determined as an abnormality.

FIG. 7 is a schematic diagram for describing a second exemplary color distribution range in the base region of a sheet. FIG. 7 illustrates a pre-printing color distribution range and the position of toner scattered during printing in a Lab color space. As illustrated in FIG. 7, in this example, the lightness L of the scattered toner is higher than the pre-printing color distribution range.

(Case where Color of Toner is Close to Tint of Base)

Further, for example, in a case where the tint of scattered toner is close to the tint of the base region, it becomes difficult to visually distinguish between the scattered toner and the base pattern. In that case, a pre-printing color distribution range may be set to, for example, a range broader than an actual pre-printing color distribution range.

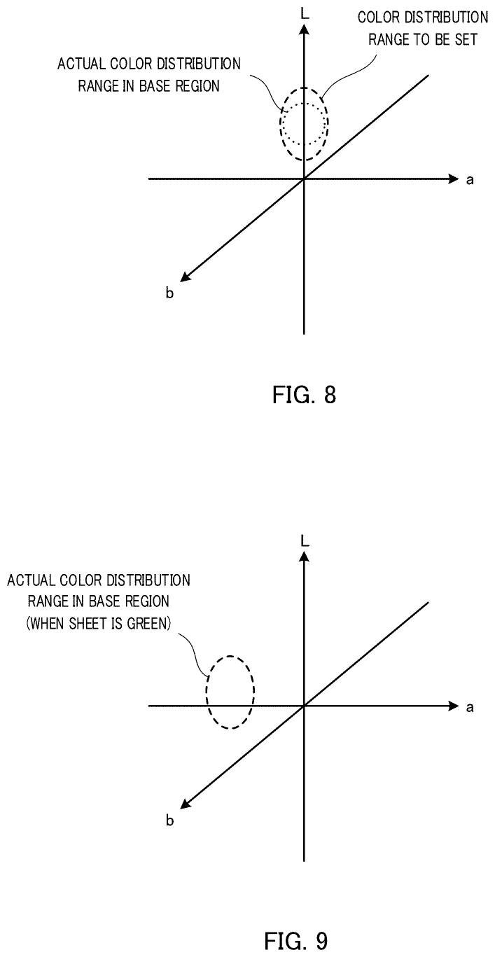

FIG. 8 is a schematic diagram for describing a third exemplary color distribution range in the base region of a sheet. FIG. 8 illustrates an actual pre-printing color distribution range and a pre-printing color distribution range whose range is broadly set.

As described above, by configuring a pre-printing color distribution range to be broader than an actual range, toner scattering which is difficult to visually distinguish is not detected as an abnormality.

(Case where Color of Sheet is Other Than White)

In a case where the color of a sheet is different from the above-described “white”, a pre-printing color distribution range in the sheet is formed at a position different from on the L axis.

FIG. 9 is a schematic diagram for describing a fourth exemplary color distribution range in the base region of a sheet. FIG. 9 illustrates a pre-printing color distribution range when a sheet as a recording medium is green. As illustrated in FIG. 9, when a sheet is green, a pre-printing color distribution range is formed at a position different from that when a sheet is white.

As described above, even in a case where the color of a sheet is green or the like different from white, it is possible to detect whether there is an abnormality in the sheet, on which an image has been formed, by comparing color distribution ranges before and after printing as described above.

### (Flow of Processing)

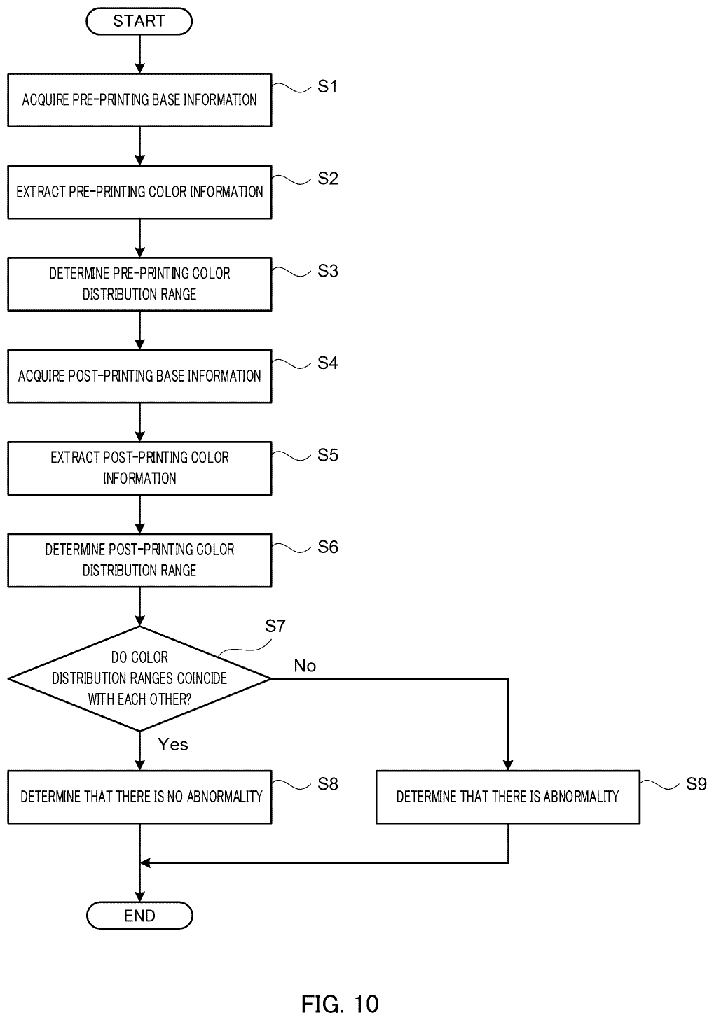

FIG. 10 is a flowchart illustrating an exemplary flow of the abnormality detection processing according to the present embodiment. In the flowchart illustrated in FIG. 10, processing by each unit of the controller 600 is illustrated.

In step S1, the base information acquirer 611 of the controller 600 acquires pre-printing base information before printing on a sheet is performed. The pre-printing base information is read by, for example, the sensors 301 and 302 of the reader 300 and is supplied to the controller 600. The acquired pre-printing base information is stored in the storage 615.

In step S2, the color information extractor 612 reads the pre-printing base information from the storage 615. Then, the color information extractor 612 extracts pre-printing color information from the read pre-printing base information. In step S3, the distribution range determiner 613 determines a pre-printing color distribution range based on the pre-printing color information extracted by the color information extractor 612.

In step S4, the base information acquirer 611 acquires post-printing base information after printing on the sheet is performed. In step S5, the color information extractor 612 extracts post-printing color information from the post-printing base information acquired by the base information acquirer 611. In step S6, the distribution range determiner 613 determines a post-printing color distribution range based on the post-printing color information extracted by the color information extractor 612.

Next, in step S7, the comparer/determiner 614 compares the pre-printing color distribution range determined in step S3 with the post-printing color distribution range determined in step S6, and determines whether the two color distribution ranges coincide with each other.

As a result of the comparison, in a case where the two color distribution ranges coincide with each other (step S7: Yes), the comparer/determiner 614 determines in step S8 that there is no abnormality in the printed image. On the other hand, in a case where the two color distribution ranges do not coincide with each other (step S7: No), the comparer/determiner 614 determines in step S9 that there is an abnormality in the printed image.

Here, in the abnormality detection processing, for example, the reader 300 reads, each time a sheet is fed from the sheet feeder 200, the pre-printing base information of the sheet. That is, the base information acquirer 611 of the controller 600 acquires new pre-printing base information for each sheet.

Note that, the acquisition of pre-printing base information is not limited to this example. For example, the reader 300 and the base information acquirer 611 may read new pre-printing base information and supply the read information to the base information acquirer 611 in a case where the specification of a sheet to be used has become different. Specifically, for example, in a case where the state of the sheet feeder 200 changes, such as when the types of sheets to be accommodated in the sheet feeding trays 201, 202, and 203 of the sheet feeder 200 change, the reader 300 reads the pre-printing base color information of a conveyed sheet and supplies the pre-printing base color information to the base color information acquirer 611.

Further, for example, the base information acquirer 611 may use the pre-printing base information of sheets stored in the storage 615 when the sheets are identical. That is, the base information acquirer 611 may acquire the identical pre-printing base information from the storage 615 until the type of sheets changes.

As described above, in the image forming system 1 according to the present embodiment, pre-printing base information and post-printing base information are acquired. Then, it is determined based on the pre-printing base information and the post-printing base information whether there is an abnormality in a recording medium after printing. In a case where an abnormality occurs in a recording medium after printing, the state of the base of the recording medium changes. For this reason, by determining based on base information before and after printing whether there is an abnormality in the above-described manner, it is possible to accurately detect an abnormality in the recording medium on which printing has been performed.

Although embodiments of the present invention have been described and illustrated in detail, the disclosed embodiments are made for purpose of illustration and example only and not limitation. The scope of the present invention should be interpreted by terms of the appended claims.

What is claimed is:

1. An inspection apparatus, comprising a hardware processor, wherein
the hardware processor
acquires pre-printing base information of a recording medium before printing and post-printing base information of the recording medium after the printing, and
determines based on the pre-printing base information and the post-printing base information whether there is an abnormality in the recording medium after the printing.

2. The inspection apparatus according to claim 1, wherein
the hardware processor
determines, based on the pre-printing base information, a pre-printing color distribution range in the recording medium before the printing, and determines, based on the post-printing base information, a post-printing color distribution range in the recording medium after the printing, and
determines based on a difference between the pre-printing color distribution range and the post-printing color distribution range whether there is the abnormality in the recording medium after the printing.

3. The inspection apparatus according to claim 2, wherein
the hardware processor determines the pre-printing color distribution range such that the pre-printing color distribution range is broader than an actual color distribution range based on the pre-printing base information.

4. An image forming system, comprising:
a reading apparatus that reads pre-printing base information of a recording medium before printing, the recording medium being a recording medium to be conveyed:
an image forming apparatus that forms an image on the recording medium conveyed from the reading apparatus; and
the inspection apparatus according to claim 1.

5. The image forming system according to claim 4, wherein
the reading apparatus reads the pre-printing base information each time the recording medium is supplied.

6. The image forming system according to claim 4, further comprising a supply apparatus that supplies the recording medium before the printing to the reading apparatus, wherein
the reading apparatus reads the pre-printing base information each time a state of the supply apparatus changes.

7. The image forming system according to claim 4, wherein:
the inspection apparatus further includes a storage that stores the pre-printing base information, and
the hardware processor uses, in a case where a plurality of the recording media to be conveyed is an identical recording medium, the pre-printing base information stored in the storage.

8. The image forming system according to claim 4, wherein:
the reading apparatus extracts a print region and a base region in the recording medium, and
the inspection apparatus determines whether there is an abnormality in the recording medium in the base region.

9. The image forming system according to claim 8, wherein
the inspection apparatus determines, with respect to the base region, whether there is the abnormality in the recording medium.

10. An abnormality detection method, comprising:
acquiring pre-printing base information of a recording medium before printing and post-printing base information of the recording medium after the printing; and
determining based on the pre-printing base information and the post-printing base information whether there is an abnormality in the recording medium after the printing.

11. A non-transitory computer-readable recording medium storing a program that causes a computer to execute the abnormality detection method according to claim 10.
